(19) United States
(12) Patent Application Publication
(10) Pub. No.: US 2008/0040663 A1
(43) Pub. Date: Feb. 14, 2008

(54) Method, System and Computer Program Product for Citation Metadata Capture

(75) Inventors: Alexander Johnson, Portland, OR (US); Scott W. Nelson, Beaverton, OR (US); Hal A. Porter, Portland, OR (US); Joshua R. Poulson, Ridgefield, WA (US); Geoff Smith, Portland, OR (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/464,343

(22) Filed: Aug. 14, 2006

(51) Int. Cl. G06F 17/00; G06F 3/048

(52) U.S. Cl. 715/256; 715/255; 715/769; 715/770

(57) ABSTRACT

A method for automatically adding citation information to a document, the method comprising: detecting an occurrence of a copy operation in a metadata aware application; capturing citation metadata associated with the copied material in the metadata aware application; detecting a paste command in a metadata aware word processing application; determining a document type from the metadata aware word processing application; formatting the captured citation metadata in response to the document type, the formatting including assigning tags to the citation metadata; and providing the formatted citation metadata to the metadata aware word processing application for generation a citation information.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to document creation, and particularly to a system for automatically capturing and processing citation metadata from a reference document.

2. Description of Background

When writing technical papers or weblog entries it is important to correctly cite references to other work. However, it is difficult to determine and document citations while writing a paper. Also, working on gathering the relevant citation information distracts from the process of writing. When copying and pasting relevant information from one electronic format to another, the metadata is available, but no computer system exists to insert the relevant information into the target document. Thus, there is a need in the art for a system that facilitates capture of citation data from a reference document.

### SUMMARY OF THE INVENTION

The shortcomings of the prior art are overcome and additional advantages are provided through the provision of a method for automatically adding citation information to a document, the method comprising: detecting an occurrence of a copy operation in a metadata aware application; capturing citation metadata associated with the copied material in the metadata aware application; detecting a paste command in a metadata aware word processing application; determining a document type from the metadata aware word processing application; formatting the captured citation metadata in response to the document type, the formatting including assigning tags to the citation metadata; and providing the formatted citation metadata to the metadata aware word processing application for generation a citation information.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which facilitates capture and processing of citation metadata.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system for citation metadata capture and processing;

FIG. 2 illustrates one example of a process for citation metadata capture and processing; and

FIG. 3 illustrates one example of citation metadata and associated material.

The detailed description explains the preferred embodiments of the invention, together with advantages and features, by way of example with reference to the drawings.

### DETAILED DESCRIPTION OF THE INVENTION

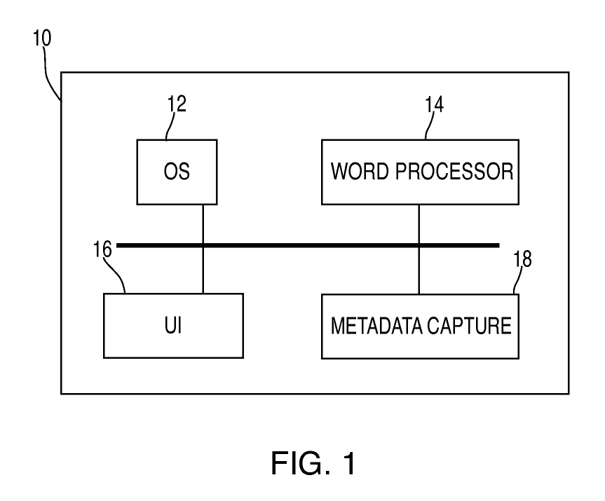

Turning now to the drawings in greater detail, it will be seen that in FIG. 1 there is illustrated an exemplary system 10. System 10 may be a general-purpose computer executing a computer program in a storage medium to perform the functions described herein. The system 10 includes an operating system 12 as known in the art. A user interface 16 accepts input from a user and includes devices such as a keyboard, mouse, display and associated software drivers for these components. A word processing application 14 runs on the system 10 and may be any known word processing package. The word processing application 14 may be used to generate documents, which include materials such as text, web postings, drawings, etc. The term document is used herein to reference a variety of materials.

System 10 includes a metadata capture module 18 that interacts with the word processor 14 upon detection of certain actions. The metadata capture module 18 is an application running along with the word processor 14. The metadata capture module 18 detects when a user has copied text having associated citation metadata and interacts with the word processing application 14 to automatically insert citation information in the document when the associated text is pasted in the document.

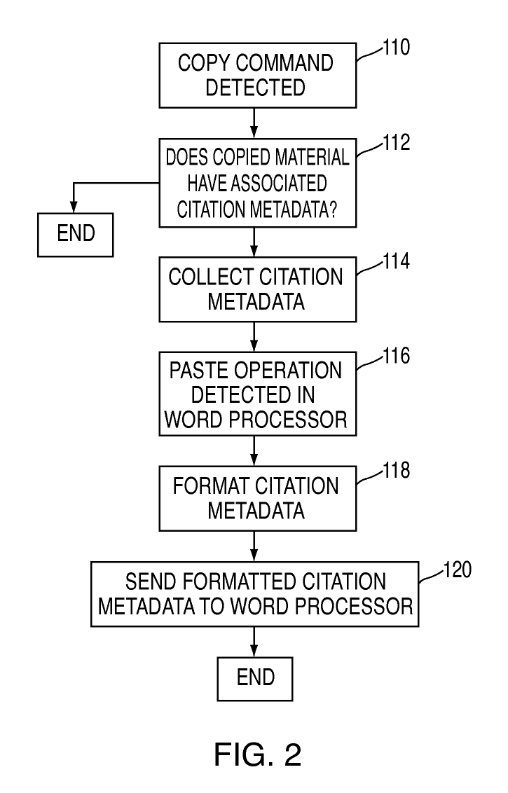

FIG. 2 is a flowchart of an exemplary process for capturing citation metadata and processing the citation metadata in a word processing application. The processing is implemented by the metadata capture module 18. The process begins upon detection of a copy command at step 110 by a metadata aware application. The metadata capture routine may monitor the user interface 16 and/or the operating system 12 to detect when the user has selected text, graphics, etc. for copying. It is understood that the copied material need not by copied from a word processor, but may be copied from a variety of sources such as spreadsheets, HTML files, etc.

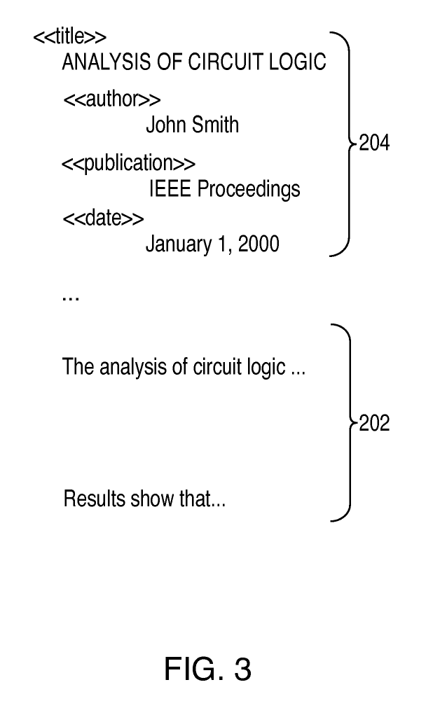

When a copy command is issued, the metadata capture module 18 determines whether the copied material has citation metadata associated therewith at step 112. FIG. 3 illustrates exemplary text having citation metadata associated therewith. As shown in FIG. 3, material 202 is associated with citation metadata 204. The material 202 is text, but it is understood that other types of material (e.g., graphics) may be processed as described herein. The citation metadata 204 includes bibliographic information such as title, author, publication name, publication date, URL, etc.

If the copied material does not have citation metadata associated therewith, then the process ends. Otherwise, flow proceeds to step 114 where the metadata capture module 18 captures the citation metadata. Existing tools may be used for capturing and formatting the citation metadata.

The citation metadata is retained until a paste operation is detected in a metadata aware application at step 116. In the exemplary system in FIG. 1, the word processor application 14 is a metadata aware application. This may be detected by the metadata capture module 18 monitoring commands in the word processing application 14.

When a paste command is detected, the metadata citation module 18 formats the citation metadata into an appropriate format. A variety of formats may be used such as APA, MLS, Chicago, legal citation or other format for pasting into a written document. If the word processing application 14 is being used to generate a web posting, the URL, title, and author information may be placed in the appropriate format at step 118. The metadata capture module 18 may query the word processing application 14 to determine the type of document being generated. Word processors often allow the user to designate a document type upon creating a new document. The document type can be used by the metadata capture module 18 to properly format the citation metadata. The metadata capture program 18 recognizes that the user is pasting to a metadata-aware application and creates the appropriate metadata tags, such as <blockquote>tags, cite=tag for a URL and a title=tag for the title, author, and other information.

Once the citation metadata has been formatted, the formatted citation metadata is provided to the word processing application at step 120 and is associated with the material pasted into the word processing application. The word processing application 14 uses the tags in the formatted citation metadata to create the appropriate footnote, bibliography entry, and/or quotation format for the material that was pasted. Additionally, the copied material from the metadata aware application may be signed with relevant signatures and key mechanisms to indicate that the copied material had not been manipulated since being referenced.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for automatically adding citation information to a document, the method comprising:
detecting an occurrence of a copy operation in a metadata aware application;
capturing citation metadata associated with the copied material in the metadata aware application;
detecting a paste command in a metadata aware word processing application;
determining a document type from the metadata aware word processing application;
formatting the captured citation metadata in response to the document type, the formatting including assigning tags to the citation metadata;
providing the formatted citation metadata to the metadata aware word processing application for generation of the citation information.

2. The method of claim 1 wherein the citation information includes at least one of a footnote, bibliography entry, and quotation entry.

3. The method of claim 1 wherein the word processing application generates a text document.

4. The method of claim 1 wherein the word processing application generates a web posting.

5. The method of claim 1 wherein the tags assigned to the citation metadata includes a title tag identifying a title of a source of the citation metadata.
